(19) United States
(12) Patent Application Publication
(10) Pub. No.: US 2006/0237239 A1
(43) Pub. Date: Oct. 26, 2006

(54) Personal utility vehicle (PUV)

(76) Inventors: Daniel Bruner, Cordova, IL (US); Daniel E. Kaiser, Henderson, NV (US)

Correspondence Address: LAW OFFICE OF JAY R. HAMILTON, PLC., 331 W. 3RD ST., NEW VENTURES CENTER SUITE 100, DAVENPORT, IA, 52801, US

(21) Appl. No.: 11/410,455

(22) Filed: Apr. 24, 2006

Related U.S. Application Data
(60) Provisional application No. 60/674,529, filed on Apr. 23, 2005.

(51) Int. Cl. B62D 11/00

(52) U.S. Cl. 180/6.7; 180/9.1; 701/41

(57) ABSTRACT

A powered personal utility vehicle having a quick-change body configuration with a mating tray assembly and a universal chassis is disclosed. The upper level of the mating tray houses electronics while the lower level engages with the universal chassis to form the personal utility vehicle. Reconfigurations are simplified with plug and play design electronics. Vehicle traction is increased through a specialized track and drive wheel design that improves contact between the between the surfaces allowing operation in multiple environments. The two-piece wheel design allows assembly of the inflatable drive molded balloon tire. Adjustment of inflation levels of the balloon tires controls track tension. Control is either manually programmed into the on board central processing unit, or via carrier signals. Semi and fully autonomous operation is disclosed. Advanced operator interaction functions using two-way real time video and audio are disclosed along with LED and GPS systems. The invention as disclosed is configurable for a range of uses, load capacities and sizes.

### CROSS REFERENCE TO RELATED APPLICATIONS

(Not Applicable)

The present application claims priority from provisional utility patent application No. 60,674,529 filed Apr. 23, 2005 and incorporated by reference herein.

### FIELD OF THE INVENTION

The present invention relates to improvements in carts, caddies motorized or not, carts, caddies, wagons, dollies, and elevates the old technology to that of a personal utility vehicle.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND OF THE INVENTION

Personal convenience equipment such as motorized and or human powered, carts, caddies, wagons, dollies and or carts herein embrace a way for humans to carry personal items necessary for work or play. Some of these are simple human powered, wire framed or tubular constructed carts with various assortments of pockets, straps, seats, tables, and compartments. Typically these carts are designed for smooth surface operation and not rough terrain as shown in U.S. Pat. Nos. 4,550,930; No. 5,159,777 and No. 5,193,842.

Also as found in U.S. Pat. Nos. 4,724,681 and No. 5,407,218 many times the carts are simply two-wheeled ice chests and coolers require human input to create the motive force necessary for motion and movement. As shown these are a simple adaptation of a standard ice chest or portable cooler with handles and wheels attached.

U.S. Pat. Nos. 3,314,494, No. 4,913,252 and No. 5,316,096 teach the addition of a motor or engine. As disclosed and described, the devices are simply powered suitcases that have to be operated by a human driver standing upon or seated in or on the suitcase. Additionally, these configurations are also not designed for any sort of rough terrain. As disclosed, the carts in all ride on wheeled configurations. The aforementioned patents also do not teach carts or cart navigation systems that allow any sort of autonomous control of the cart. These patents also do not disclose or describe the capability for operation by real time video, two way communications, remote radio control and or on board programmable computer systems for a plurality of function and data processing requirements.

U.S. Pat. No. 5,180,023 teaches a remote controlled self-powered golf bag cart that has an infrared based driving controller for navigation. The design has three wheels and its preferred embodiment is to carry golf clubs. Thus, replacing the human golf caddy. As disclosed, the design lacks autonomy in it operation, real time video capabilities, two way communications, and remote radio control. The system also does not any sort of on-board programmable computer system or software useful for a plurality of function and data processing requirements.

U.S. Pat. No. 5,899,285 ('285) teaches a motorized wire caged cart requiring human efforts for physical control. This control is effectuated by physically pulling on the handle bar and using human muscle power to control directional travel. According to the '285 patent, invention is designed with two wheels and has an internal power source. The design, however, fails to teach an embodiment designed for rough terrain. The preferred embodiment as disclosed by the patent is that of a shopping cart. As disclosed, the design lacks autonomy in it operation, real time video capabilities, two way communications, and remote radio control. The system also does not have any sort of on-board programmable computer system or software useful for a plurality of function and data processing requirements.

U.S. Pat. No. 6,390,216 is a motorized tricycle for humans to ride upon and it steers by means of handlebars similar to that of bicycles and motorcycles; it has no useful storage capabilities. It is also is not designed for rough terrain and lacks remote controlled operation. The system also does not have any sort of on-board programmable computer system or software useful for a plurality of function and data processing requirements.

U.S. Pat. No. 6,592,656 ('656) is a remote controlled cooler that has a drive system built into the housing structure of the container. The drive system is dependent on the cooler housing structure for structural integrity and connects a single powered engine or motor through a drive shaft to the drive system. A suspension system capable of absorbing more than a minor shock is not taught. Furthermore, the '656 patent teaches interchangeable drive wheels, paddle wheels, spiked wheels and a tank like track system having a single source input for motive force. Each of the supporting four (4) wheels can be changed out to be configured for different terrains and environments including water. The various combinations of wheel and tracks found in patent '656 do not teach a clear design as to how to steer this powered housing with any sort of finite control.

Another limitation found in the teaching of patent '656 is that the drive system is part of the housing. This limits the delivery of power to the drive wheels. As taught by '656, to rotate the drive wheels, power from the motor or engine must be delivered to the driveshaft connected through a connected differential system and then re-directed to an axel connecting the drive wheels to the differential system. As configured by '656, the single structure that houses all of the drive components (i.e. axle, differential and drive shaft) is a single box-like configuration defined as a housing.

U.S. Pat. No. 6,540,569 ('569) refers to an integrated utility vehicle and teaches the combination of a motorcycle with a personal watercraft. Patent '659 does not teach an autonomous method of control or any combination of the embodiments with real time video capabilities, two way communications, remote radio control and or on board programmable computer systems for multiple functions and or for the processing of data.

### SUMMARY OF THE INVENTION

A personal utility vehicle is described herein having dramatic improvements over previous patented designs in applied operational technology. The improvements include but are not limited to traction, traction control, power control, load carrying capabilities, adaptability for different conditions or user needs by allowing interchangeable body styles and an expandable chassis technology to meet the demands of it users. In addition, a tracking and control system is disclosed allowing for autonomous control and communications from the personal utility vehicle.

As described the personal utility vehicle, which is preferably configured for remote control, is driven by at least two independent systems each having high torque electric motors connected to the respective drive wheels of the tracked systems. As disclosed, each side has two (2) bi-directional drive motors connected in parallel to the track drive wheels of one side while there are also two (2) bi-directional drive motors connected in parallel to the drive wheels on the other side.

Energy is delivered to the motors for operation through a proportional energy control configuration. The circuitry in this control system may be activated by signals from various carrier wave or frequency transmitter held and or operated by the operator. A signal-detecting device on board the personal utility vehicle then receives this transmitted signal and energizes the circuit to allow an increase and or decrease of energy to the motors respectively, or to operate them in a clockwise or counter clockwise fashion. The amount of torque developed by the motors is directly proportional to the amount of energy released by the circuit. These configurations allow the tracks to move clockwise and counter clockwise, at the same rotation rate or variable rotation rates. The result of this combination of motor arrangement and controller design is that the personal utility vehicle is able to rapidly move forward or in reverse, and or make left or right turns. The difference in rotational velocities between the left and right side track systems creates the turning of the vehicle. Another result of this configuration is that the braking capabilities are also improved to the point where the vehicle has a near zero point turning radius over three hundred and sixty degrees. This is a result of the selection of motors that act as stationary magnets. Upon activation through energizing of the circuitry, the motors may be correctly energized in opposite directions thereby allowing the opposing drive systems to work together to turn the vehicle.

In one embodiment of the invention, the personal utility vehicle may be configured for semi-autonomous operation. The operating systems for power and direction may be controlled by a central processing system that runs a software program to monitor the multiple sonic sensors strategically positioned on the vehicle. In combination the user of the personal utility vehicle wear a high frequency sonic emitter that emits a sonic pulse and or steady emitting. In operation, the sensors on the vehicle pick up and then transmit the sonic emissons. The transmission data is processed in real time by a central process system's (CPS) computer. The signals collected by the multiple sonic receiving sensors are collected and uploaded to the central processing system. The strength of the collected signals is measured, compared and analyzed to produce and execute commands necessary for operation and control of drive motors control and power circuits. The sonic sensors operate in conjunction with the central processing systems computer and calculate, based on given variables, pre-programmed into the software, necessary directions that allow the vehicle to move forward faster, slower, stop, turn or back up. This program allows the vehicle to stay in close contact with the operator while still maintaining a safe distance from the operator. The system as described also allows for emergency stops programs that are executed upon receipt of sensor indicating the operator is too close. This data will trigger the necessary operational response from the central processing systems computer. FIG. 12 further illustrates the “Follow Me” semi-autonomous operation and how it is accomplished by means of stereoscopic tracking and fixed microphones communicating data to the OS (operating systems) and how the (OS) commands the subsystems. It is also within the scope of the invention for configuration of the personal utility vehicle to include communications involving satellite based global positioning systems. It is therefore an object of the present invention to provide a personal utility vehicle. It is still another object of this invention is to provide to a personal utility vehicle that in design is sizeable depending on need.

It is still another object of this invention is to provide method and technology that allows easy configuration of chassis, power supply, electronic controls, communication, remote operation. It is another object of the invention to provide a control system for said personal utility vehicle. It is a further object of the invention to provide a proportional energy control system for the drive system of the personal utility vehicle for motivation and direction control. It is a yet other object of the invention to provide a tracking system for said personal utility vehicle.

It is a yet other object of the invention to provide a personal utility vehicle having a chassis arrangement that allows for easy selection and adoption of various body configurations.

It is a still other object of the invention to provide a track drive system that is dynamically adaptable to different terrains and conditions.

It is still another object of this invention is to provide a tracked drive system that in the drive tracks are quickly and easily adjustable in tension.

It is still another object of this invention is to provide real time visual and audio communications between operator and the vehicles environments.

It is an additional object of the invention to provide a sonic based system and method that combines semi-autonomous control and user tracking.

It is another object of this invention to provide a vehicle that may be adapted to military platforms including weapons and personnel tracking systems.

It is another object of this invention that the vehicle signal and communication system may be adapted for either military or civilian use for the recovery of lost or abducted people or property when combined with a satellite based tracking system.

### BRIEF DESCRIPTION OF THE DRAWINGS

Other objects and features of the invention will become apparent from the following detailed description when read with reference to the accompanying drawings, in which;

FIG. 1 illustrates the components found in the quick-change utility body mating tray and the universal chassis assembly of the large style PUV embodiment.

FIG. 2 illustrates the universal chassis assembly of the present invention.

FIG. 3 shows the right side of the traction drive assembly as found in one embodiment of the present invention.

FIG. 4 illustrates the tire wheel assembly.

FIG. 5 illustrates and compares different embodiments of the traction drive assembly of the present invention for different sized embodiments.

FIG. 6 illustrates the invention as configured with electronics main board and its mounting and integration in the mating tray.

FIG. 7 illustrates the remote control system with real time video and two-way voice communications as found in the invention.

FIG. 8 illustrates the stereoscopic microphone or audio receivers needed in the directional control system as found in one embodiment of the present invention.

FIG. 9 illustrates the “Follow Me” semi-autonomous operation of the apparatus and method disclosed.

FIG. 10 shows the small sized personal utility vehicle as configured with a sport memorabilia novelty body.

FIG. 11 illustrates an embodiment of the invention configured with the small sized toy style automotive body configuration.

FIG. 12 illustrates an embodiment of the inventions quick-change memorabilia style body.

FIG. 13 illustrates an embodiment of the inventions quick-change utility style body.

FIG. 14 illustrates an embodiment of the inventions quick-change automotive style body

FIG. 15 illustrates an embodiment of the disclosed apparatus configured as a combat ready utility delivery vehicle (CRUDV)

FIG. 16 illustrates an embodiment of the invention configured and sized small with sports memorabilia, utility and automotive style bodies.

FIG. 17 illustrates an embodiment of the invention configured and sized medium with sports memorabilia, utility and automotive style bodies.

FIG. 18 illustrates an embodiment of the invention configured and sized large with sports memorabilia, utility and automotive style bodies.

DETAILED DESCRIPTION - ELEMENT LISTING

| Element | Number |
|---|---|
| Body interfacing pins | 1 |
| CPU Central Processing Unit | 2 |
| PUV Interface Terminal | 3 |
| Quick-change plug an play sockets | 4 |
| Hinge Pin for Interface Terminal | 5 |
| Mating Tray Mount and division plate | 6 |
| Power cell | 7 |
| Right side flexible track | 8 |
| Mounting Tray's Division Partition | 9 |
| BLANK | 10 |
| Right rear drive motor axle shaft | 11 |
| BLANK | 12 |
| Flexible right side track traction enhancement ridge | 13 |
| Right rear drive motor | 14 |
| Left rear drive motor | 15 |
| Left rear drive motor axle shaft | 16 |
| Universal vehicle chassis assembly | 17 |
| Left rear drive motor mounting assembly | 18 |
| Universal vehicle chassis assembly's axle portal | 19 |
| Universal vehicle chassis assembly's power cell storage area | 20 |
| Flexible left side track traction enhancement ridge | 21 |
| Drive wheel axle mounting retainment cap | 22 |
| BLANK | 23 |
| BLANK | 24 |
| Left front drive motor axle shaft | 25 |
| Right front drive motor | 26 |
| Right front drive motor axle shaft | 27 |
| Axle shaft friction reduction spacer. | 28 |
| Leading edge of flexible track | 29 |
| Right rear drive wheel | 30 |
| Left side flexible track | 31 |
| Left front drive motor | 32 |
| BLANK | 33 |
| BLANK | 34 |
| Balloon tire inflation port | 35 |
| Traction surface contact areas | 36 |
| Flexible track traction enhancement groove | 37 |
| Threaded male member of the wheel assembly | 38 |
| Threaded female member of the wheel assembly | 39 |
| Drive wheel assembly | 40 |
| Auxiliary High intensity LED Area Lights | 41 |
| Digital Video Camera mounted | 42 |
| Storage Compartment side mounted | 43 |
| Storage compartment internal | 44 |
| Embodiment of the quick change sport body | 45 |
| Body Cover removable and or operable | 46 |
| Cover gripping port | 47 |
| Body cover mating hinge | 48 |
| Insulated Storage Compartment | 49 |
| Lower mated section of quick change body | 50 |
| Mating seam of body | 51 |
| Body Cover for the insulated internal storage compartment | 52 |
| Insulated internal storage compartment | 53 |
| Body carrying handle | 54 |
| Cargo pickup type bed and open storage area | 55 |
| Seat and lid combination for insulated storage area | 56 |
| Insulated forward storage area | 57 |
| Storage panel door covering recessed storage compartment | 58 |
| Storage panel opening portals | 59 |
| Non-swiveled interface sockets | 60 |
| Mating tray's 106 mounting channel for quick change body. | 61 |
| Universal Chassis 17's mating section for 106 | 62 |
| Main electronics board | 63 |
| Idler load bearing wheels free wheeling (could be powered) | 64 |
| Track Drive Assembly for Small PUV (Cargos 5-50 lbs.) | 65 |
| Track Drive Assembly for Medium PUV (Cargos 5-100 lbs.) | 66 |
| Track Drive Assembly for Large PUV (Cargos 100 > 500 lbs.) | 67 |
| General sport memorabilia style quick change body | 68 |
| General Utility style quick change body | 69 |
| General Automotive style quick change body | 70 |
| Emergency stop zone all vehicle motion stops and alarm sounds | 71 |
| to inform operator | |
| The zone where the vehicle is told to slow down and turn left | 72 |
| These zones indicate the need for additional zone readings. | 73 |
| Keep speed constant and turn left | 74 |
| Speed up and guide left | 75 |
| These zones indicate the need for additional zone readings. | 76 |
| The zone for optimal operation | 77 |
| Speed up and guide right | 78 |
| The Personal Utility Vehicle Listening for sonic transmitters | 79 |
| signals | |
| keep speed constant and turn right | 80 |
| The zone where the vehicle is told to slow down and turn right | 81 |
| Emergency stop zone all vehicle motion stops and alarm sounds | 82 |
| to inform operator | |
| PUV user emitter | 83 |
| Sonic field's focal point | 84 |
| Reference stereoscopic microphone | 85 |
| Right stereoscopic self-tracking microphone | 86 |
| Left stereoscopic self-tracking microphone | 87 |
| UHF OR VHF or other high gain Radio Control Antenna | 88 |
| High Gain Video Receiver antenna | 89 |
| VOR Voice activated microphone with external jacks | 90 |
| Video Display Screen | 91 |
| Volume controlled Speaker | 92 |
| Left drive motor system motion controller | 93 |
| Box style digital audio transceiver. | 94 |
| Right drive motor system motion controller | 95 |
| Video monitor, and camera light and controls | 96 |
| Hand held control station for remote control video and | 97 |
| operational vehicle systems | |
| Vehicle remote controlled accusation and activation systems | 98 |
| switches | |
| Transceiver Antenna | 99 |
| Voice Activated Digital Microphone | 100 |
| Mating tray plug and play receiver and transmitter Video and | 101 |
| Audio processing card | |
| Synchronized left drive motors control unit for forward reverse | 102 |
| motion | |
| Synchronized right drive motors control unit for forward reverse | 103 |
| motion | |
| Loud Speaker | 104 |
| Securing swing rings for shoulder straps | 105 |
| Mating Tray Mount Assembly | 106 |
| Trailering Accessories for additional cargo for handling | 107 |
| capabilities. | |
| PUV Situation | 108 |
| PUV Situation | 109 |
| PUV Situation | 110 |
| Chassis's mating tray mounting & receiver portal | 111 |
| Night vision capable digital micro camera | 112 |
| Automatic target tracking | 113 |
| Combat missile launcher | 114 |
| Thermally controlled storage area | 116 |
| Armor | 117 |
| Infrared | 118 |
| Illumination system | 119 |
| External Environmental sensor | 120 |
| Small configuration PUV's (Cargos 0-50 lbs.) memorabilia | 121 |
| design | |
| Small configuration PUV's (Cargos 0-50 lbs.) utility design | 122 |
| Small configuration PUV's (Cargos 0-50 lbs.) automotive | 123 |
| design | |
| Medium configuration PUV's (Cargos 5-100 lbs.) memorabilia | 124 |
| design | |
| Medium configuration PUV's (Cargos 5-100 lbs.) utility design | 125 |
| Medium configuration PUV's (Cargos 5-100 lbs.) automotive | 126 |
| design | |
| Large configuration PUV's (Cargos 50 > 500 lbs.) memorabilia | 127 |
| design | |
| Large configuration PUV's (Cargos 50 > 500 lbs.) utility design | 128 |
| Large configuration PUV's (Cargos 50 > 500 lbs.) automotive | 129 |
| design | |
| Military Body Style | 130 |
| Balloon tire | 131 |
| Mounting tray ports | 132 |

### DETAILED DESCRIPTION OF THE INVENTION

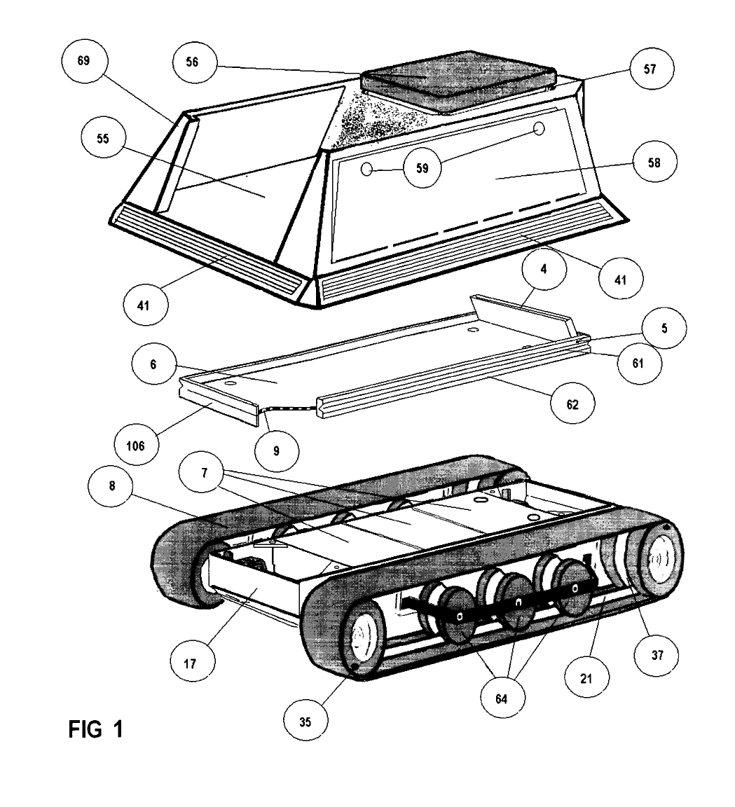

FIG. 1 provides an exploded perspective of the present invention and illustrates the components found therein including the quick-change utility body 69, the mating tray mount assembly 106 and the universal chassis assembly 17 for the PUV. In FIG. 1, the large style embodiment of the present invention is shown with the quick-change utility body style 69 in combination with the mating tray 106 and universal chassis assembly 17 supported by a flexible track 8 with idler load bearing wheels 64 which are free wheeling as shown but could be powered for heavy duty uses and cargos of fifty (50) to five-hundred (500) pounds. As shown in FIG. 1, the inventor contemplates that numerous accessories could be added to the PUV to increase capabilities and functions. Contemplated accessories for the PUV as shown include high intensity LED area lights 41 which can be controlled and powered through the main electronics board 63 located in mating tray mount and division plate 6 of mating tray 106.

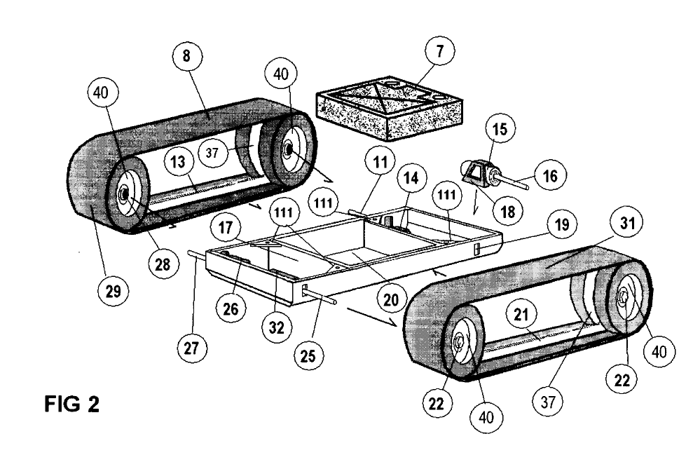

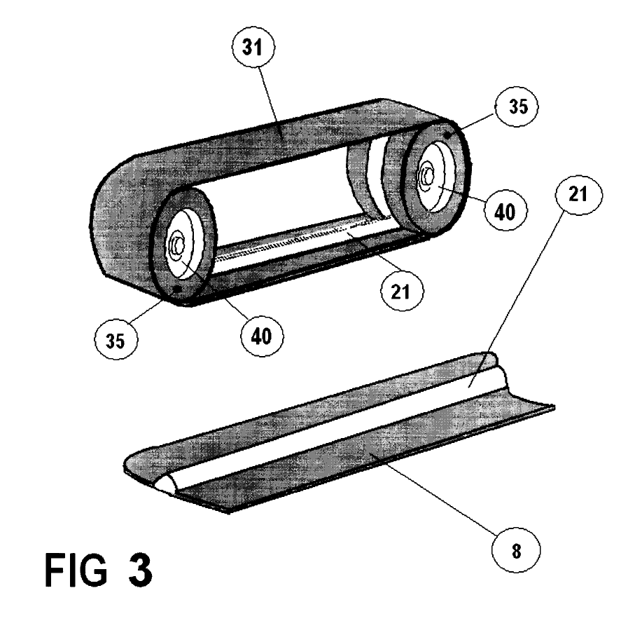

Several subsystems are required to produce the PUV as disclosed, with a first base component being the universal chassis assembly 17, which in itself has a series of subcomponents as illustrated in the exploded perspectives of FIG. 2 and detailed further in FIGS. 3-7. The universal vehicle chassis assembly 17, which has a structure that is strong enough to handle and support the design loads and limits, needed for proper operation of the invention through a range of multi-purposes and terrains. The universal chassis assembly 17 is also designed to have sufficient internal compartments 20 and specialized areas for the placement of critical subsystems and their supporting technologies. One specialized compartment is for storage of the PUV's power source or cells 7. These compartments 20 also provide a means to lower the vehicle's center of gravity further adding to stabilization of the vehicle. The mating structure of the universal chassis assembly 17 helps to facilitate the secure and proper mating of the mating tray 106 to the universal chassis assembly 17 through a plurality of means, such as a snap fit tongue and groove assembly, a wedge lock, spring snaps, magnetic locks and so on.

As shown in FIG. 1, the PUV may be outfitted with a utility style quick change body 69. When this embodiment is chosen, there are several possible body and utilitarian amenities that are possible, such as cargo pickup type bed 55 and insulated storage area 57. A seat lid 56 combination may also function to allow access to an insulated storage area 57. Additional storage area can be accessed through storage panel door 58 covering a recessed storage compartment via storage panel opening portals 59.

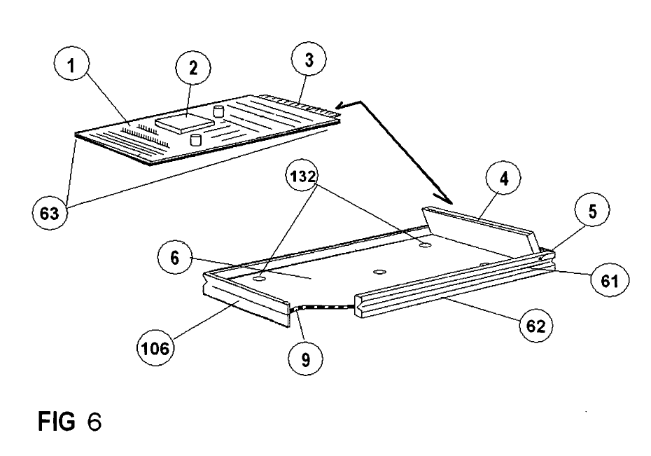

As shown, mating tray mounting channel 61 allows engagement of the quick change body 69 to the PUV mounting tray assembly 106. Lower chassis mating section 62 of mating tray 106 is then attached to the universal vehicle chassis assembly 17, thus securely mating quick change body 69 to vehicle chassis assembly 17. Furthermore, as shown in FIG. 1 and in FIG. 6, mounting tray port(s) 132 align and engage with universal vehicle assembly alignment fasteners 111. Mounting tray mount and division plate 6 separates the upper and lower sections of mounting tray assembly 106 and also creates a recessed compartment for secured placement of electronics board 63 which is engaged with quick-change plug and play socket 4. See cut-away view 9 of mounting tray mount and division plate 6 illustrating the upper and lower sections of mounting tray 106. Although not shown, it is understood by those skilled in the arts that the interior portions of the quick change body 69 may be fitted with a rim or ridge to fit with the mating tray mounting channel 61 and provide an interlocking fit. The mounting tray 106 channel 61 is one means of interchangeably fitting the quick change body to the universal chassis assembly 17 as recited in the claims. Other means to accomplish a similar function would include a snap fit, wedge locks, spring snaps, magnetic locks and combinations of thereof.

FIG. 2 provides a detailed view of the vehicle chassis assembly 17 of the invention and utilization of the various components of the universal chassis assembly 17 and how it applies to the present invention. The universal vehicle chassis assembly 17 system is made up of many subsystems the base component of which is universal vehicle chassis assembly 17 as outlined in FIG. 2. The main compartments of the universal chassis are those of the storage compartment 20 for the power cell 7 and the open areas that house the drive motor assemblies 14, 15, 26 and 32 as well as the drive motor mounting assembly 18, which are needed for the support and mounting of drive motors 14, 15, 26 and 32. The motor mounting assembly 18 can be designed to house a sophisticated suspension system that will allow for vibration damping, fluid like movement, and at all times ensuring a secure placement and mating of the motor assembly 14, 15, 26 and 32 to the universal chassis 17. Each drive motor 14, 15, 26 and 32, respectively, as placed, allows for the drive motor axle shafts 11, 16, 25 and 27 to protrude through the chassis 17, at each respective portal 19, as shown in FIG. 2. Each drive motor axle shaft 11, 16, 25 and 27 is respectively (front, rear, left, right,) connected to the appropriate drive wheel assembly 40 as shown in FIG. 2. Each vehicle axle when attached to the appropriate wheel assembly is stabilized and restricted from movement to avoid rubbing the universal vehicle chassis assembly 17 during operation by a drive wheel axle shaft portal friction reduction spacer 28. The drive wheel 40 shown at FIG. 3 is held in place on the drive motor axle shaft, by a drive wheel axle mounting retainment cap 22 on opposing sides of the universal vehicle chassis assembly 17. The combination and arrangement of drive wheels and motors are one means of a drive system as recited in the claims.

FIGS. 3-5 illustrate the traction drive assembly and subsystem is made up of four main elements working together to allow control of drive traction. These systems include the flexible tracks 8 and inflatable drive wheel assembly 40 which act in a similar fashion to the tracked system used on dozers and other tracked vehicles of today. The major difference is in the flexibility and materials used in this design along with the tension adjustment features of inflatability. Next, is the traction enhancement ridge 21 designed for mating into the molded and grooved inflatable drive wheel assembly 40 as detailed in FIG. 3. Thirdly, is the inflation control which is accomplished by means of a special self-sealing needle valve 35 located in the side wall of each wheel assembly 40 of FIG. 3 and FIG. 1. Finally, the preceding systems are operated in combination with the semi-independent four (4) motor drive design as shown in FIG. 1 at 14, 15, 26 and 32 to maximize traction control and torque delivery.
1. The track and drive wheel in combination with the flexible track design provides the ability to adjust track tension by the inflation of the drive wheel balloon tires and the flexible track also referred to herein as 31 and 8, and as shown in FIG. 2. The flexible track, 31 and 8, have a unique traction enhancement feature, assigned 13 and 21, in FIG. 2 and known as a “Traction Enhancement Ridge™”. This enhancement ridge helps to increase traction of the flexible track 31 and 8 by increasing the surface area of contact between each of the four (4) drive wheels shown in FIG. 2, which contain traction and directional enhancement grooves as, indicated by 37 which are included in all drive wheels used with the flexible track 31 and 8. This enhancement also resists the tendency of lateral shifting of the flexible track (31 and 8) during acceleration and normal operation when directly mated up with the molded balloon tires 131 design feature. As disclosed and described, this traction system is more useful by the addition of having all four (4) drive wheel assemblies 40 under independent power and controlled by the central processing unit 2, shown in FIG. 6. This complex combination of the systems allows for maximum torque being delivered to the leading edge of the flexible drive wheel 40 in concert with flexible tracks 8 and 31. The combination and arrangement of drive wheels 40, balloon tires 131 and flexible tracks 8, 31 are one means of a traction system as recited in the claims. In another embodiment, the air supply for inflation of the balloon tires may be included within the personal utility vehicle. (Not shown) The air supply system may be controlled by the electrical control system of the personal utility vehicle. Additionally, as known by those skilled in the arts, an auto-inflation system may be added wherein the control of the air to be delivered to the balloon tires 131 may be dynamically responsive to the environmental surface conditions facing the personal utility vehicle.

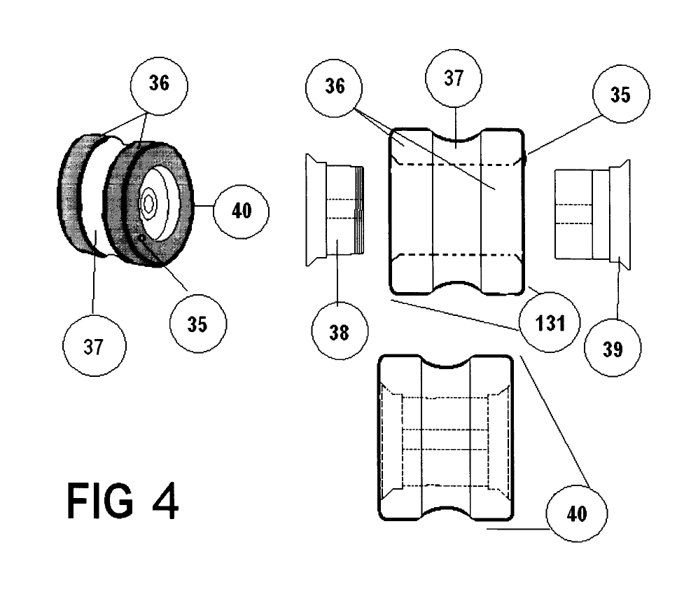

As further detailed in FIGS. 3-5, the vehicle's contact with external surfaces is delivered through a flexible track 8 which is track-like but has additional improvements through the flexible track's traction enhancement ridge 13, which acts to resist lateral movement and helps to facilitate engaged interface between the enhancement ridge 37 and the drive motor wheel assembly 40 by a formed and inserted fit between the traction enhancement ridge 21 and the traction enhancement groove 37 found on balloon tire 131 mounted to drive wheel assembly 40. As detailed in FIG. 4 the inflation port 35 of balloon tire 131 provides a simple and secure way to control inflation of the tire around the drive wheel assembly 40 thereby allowing changes in tire diameter to adjust the flexible track 8 tension.

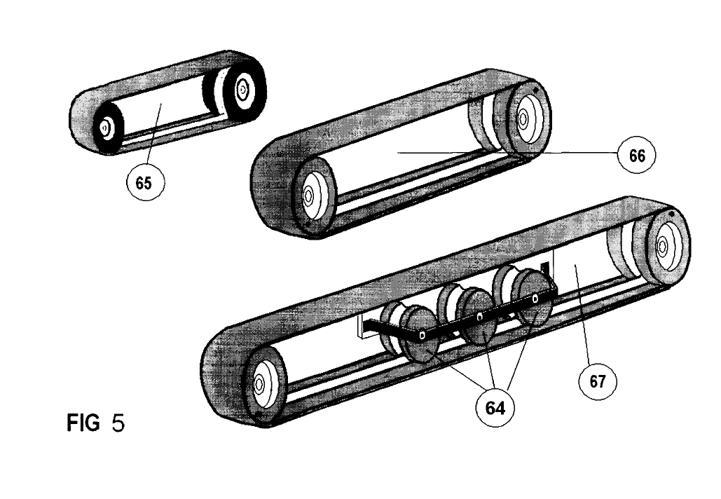

FIG. 5 illustrates the appropriate sized design of the traction drive assembly of the present invention. This figure illustrates that the invention disclosed and claimed herein may be “sized” for different applications. Said sizing includes changing the flexible drive wheel connection loop assembly design, with small “sized” embodiment 65 being typically of a type for small cargo loads such as less than five pounds, typically the medium “sized” design is mounted to support medium “sized” embodiment for cargos ranging from five to fifty pounds. The typical heavy duty or large “sized” design 67 for heavier cargos ranging from fifty to five-hundred pounds. As shown in FIG. 5, in the large sized design, the increased weight to be carried is distributed over increased length of the flexible drive wheel connection loop assembly 67 by the addition of idler load bearing wheels 64. Those practiced in the arts will understand that that these wheels may be used as either load distributing wheel without powered engagement or powered for increased traction and power distribution.

FIG. 6 illustrates engagement and relationship between the mating tray 106 universal chassis assembly 17 and the quick-change bodies 69 as shown in FIG. 1. All of the major processing and electronic control systems may be stored in the mating tray 106. This mating tray 106 receives its electrical power from the power cell 7 stored in the center of the universal chassis 17 for stability and proper center of gravity. The quick-change plug & play sockets 4 provide an easy way to retrofit and customize each embodiment to the users needs. The mating tray 106 mounts and or securely connects the two sections, 69 and 17 together, thus allowing them to operate as a single unit. Quick change plug and play socket 4 allows delivery of electrical power from power cell 7 to the main electronics board 63 which redirects power from power cell 7 through socket 4 to the electrical connections supplying drive motors 14, 15, 26 and 32. Quick change plug and play socket 4 supplies the necessary circuitry for universal chassis assembly 17 interface with quick change body 69 through the mating tray 106. To better accommodate changes between body configurations and accessories, the quick change swivel socket 4 is designed with a hinge pin interface terminal 5. Also as shown in FIG. 6, the main electronics board 63 for the PUV is composed of a printed circuit board 1 and a central processing unit (CPU) 2. The vehicle interface terminals 3 of the main electronics board 63 are designed to allow for bi-directional communication with the electronics of the universal chassis assembly 17 electronic components through the swivel socket 4. The swivel socket 4 is one means to allow a “plug and play” like interface between the universal chassis and interchangeable bodies as recited in the claims.

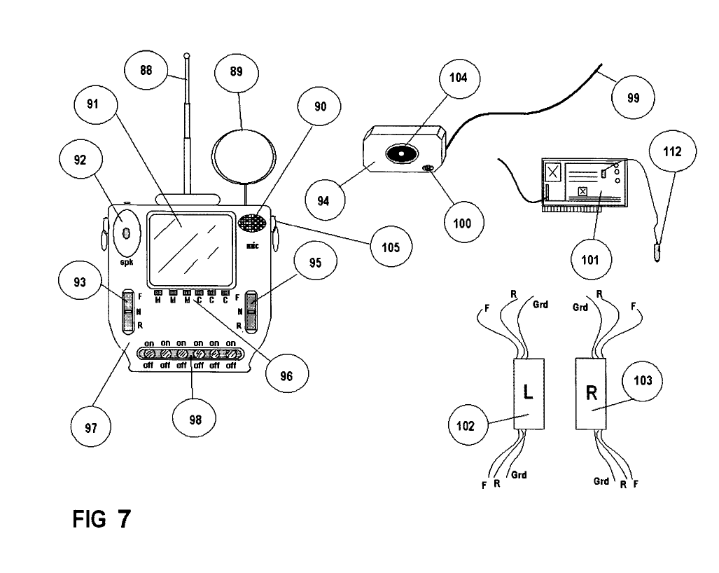

FIG. 7 illustrates the interfacing components of the personal utility vehicles (PUV)'s RF remote control and interactive systems also known as the hand-held control station for remote control video and operational vehicle systems 97. It is carried and operated by the user to control the operation and interact with the PUV's onboard subsystems. This is accomplished via a radio frequency transmitted to and received from via RF video and audio. The PUV's controls are operated and commands are completed in real time in a bi-directional manner. The UHF/VHF or other high gain radio control antenna 88 is needed to transmit and receive (RF) radio signals in analog and or digital wavelengths. Also located in this unit 97 is the high gain video receiver antenna 89 for receiving real time video transmissions from the PUV's onboard camera 112. The voice activated microphone with external jacks 90 has its transmitting counterparts which include a loud speaker 104 and its VAM 100 also located on board the PUV, thus allowing for true bi-directional duplex communications. The video display screen 91 allows the operator to, in real time, view the environment that the PUV is in at the time for its own onboard night vison capable digital micro camera 112. The volume controlled speaker 92 allows the operator to communicate with duplexing communications in real time with the PUV. The Video Monitor 91 and night vision capable digital micro camera 112 can be adjusted with the built video monitor, and camera light and controls 96 also located onboard the hand held control station for remote control video and operational vehicle systems 96. Also built into the hand held control station for remote control video and operational vehicle systems 97 are the PUV's remote controlled acquisition and activation systems switches 98, left drive motor system motion controller 93 and the right drive motor system motion controller 95, securing swing rings for shoulder straps 105 that allow for easy strapped and or suspended support of the hand held control station for remote control video and operational vehicle systems 97. Motion controls for the synchronized left drive motors power control units for forward reverse motion induction 102 and the synchronized right drive motors control unit for forward reverse motion induction 103 are the left drive motor system motion controller 93 and right drive motor system motion controller 95. Although not shown, sensors may be added to the unit to monitor the vitals of the personal utility vehicle, for example, power supply and battery levels. External sensors may also be added to allow for evaluation of external terrain conditions.

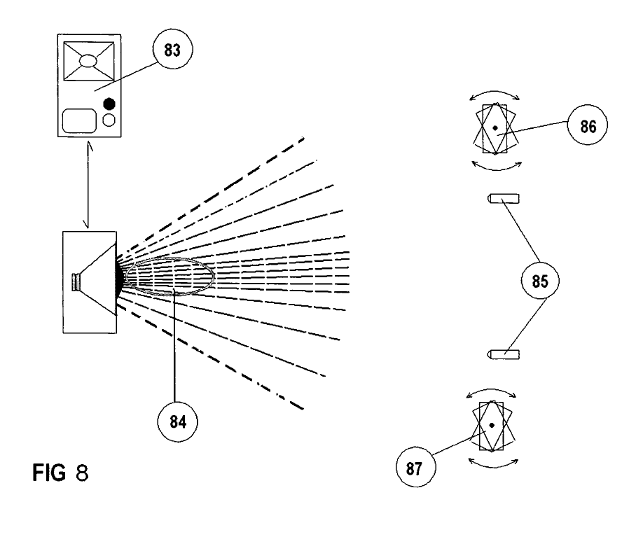

FIG. 8 illustrates the stereoscopic microphone or audio receivers needed in the directional control system as found in one embodiment of the PUV. The PUV user's emitter 83 may be portable and battery operated, belt worn, manually switch on or off, stereoscopic, quadraphonic sonic emitter 83 for the operator to wear, operation of the PUV's systems to properly communicate commands necessary for semi-autonomous operations. The sonic field focal point 84 which is generated by the emitter 83 allows the PUV's direction control systems to determine where in this generated field the PUV is at. This design allows for proximity directional controls, but with the system integration of GPS receivers, the possibility of an out of proximity zone control may be used to allow the PUV to move itself back into the preferred proximity zone. The same computer control systems work but a secondary logic program would run the operations until at such time the PUV comes back into proximity control.

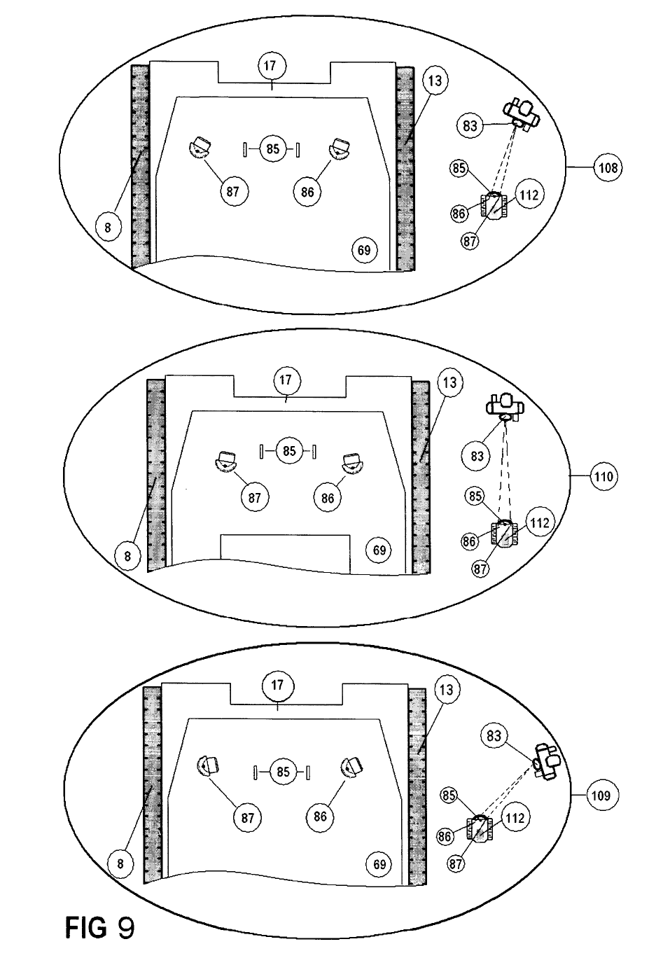

As further shown in FIG. 9, the mounted directional tracking microphone, left 87 and right 86, respectively, in relationship to the reference microphone 85, quick change body 17 and the tracks 8. This configuration is critical in its methodology as the left 87 and right 86 microphone pivots via a drive motor or servo controlled by the on-board computer to track the focal point 84 of the mobile emitter 83 worn by the operator.

There are three different operational situations shown in FIG. 8 which are identified as 108, 109 and 110. Situation 108 shows the relative positions of the left and right 86 servo controlled stereoscopic self-tracking microphones, 86 and 87, respectively, in relationship to the stationary centering stereoscopic microphone 85. The approximate mounting position of the microphones on the PUV's quick-change body 69 when the operational components 8, 13, 17, and 69 are all placed together to form a working vehicle. The small drawing for each situation indicates the approximate number of degrees and direction of the self-tracking microphones 86 and 87 must turn to follow the emitters 83 focal point 84. The onboard computer will receive data from these microphones and based on the computer's programming logic which in turn will direct the drive wheels to speed up or slow down or even stop in accordance with it programmed needs. The data received from the microphones will determine the approximate the distance and direction of the wearer of the emitter 83.

FIG. 9 further demonstrates the PUV emitter's use. The premise on which the semi-autonomous directional control/guidance system works or operates, is that when the stereoscopic directional system 83, 84, 85, 86, and 87 is engaged and operational, the majority of the movement and directional functions of the PUV are to be controlled by the onboard computer. The needed data is received by the microphones and transmitted to the CPU 2 for proper processing. The CPU 2 programming is designed to be variably set to a specified distance and speed of travel necessary to place and maintain the PUV within the proper proximity of the emitter 83. The swivel capability of the self-tracking stereoscopic and or multi-scopic capabilities of the microphones 85, 86 and 87 allows the computer the differential data necessary for semi autonomous operation. From a fixed reference point indicated by the stationary microphone 85 and its variable tracking microphones 86 and 87. The differentials are what the computer can use to determined distance speed and direction for the PUV to travel. The combination and arrangement of stereoscopic microphones, audio receivers, emitters, global positioning systems and computers are one means of an autonomous control system as recited in the claims.

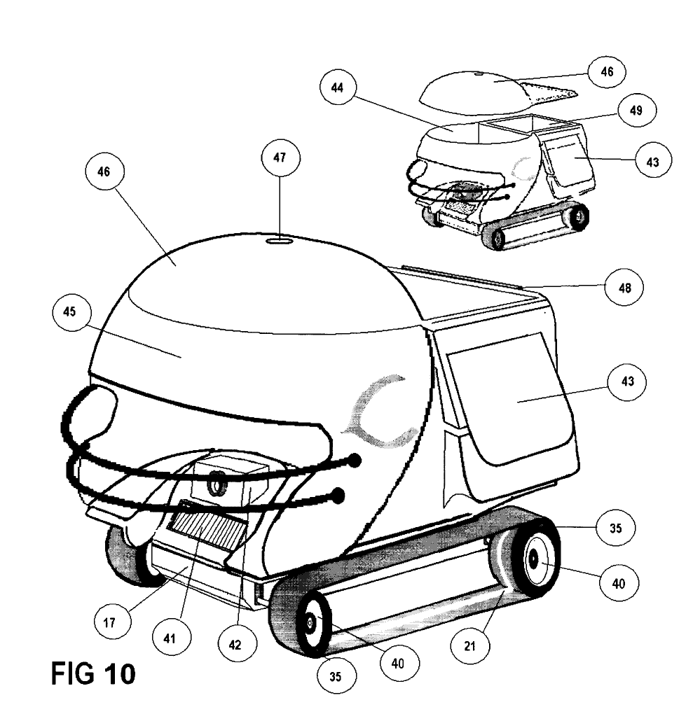

FIG. 10 shows the small sized personal utility vehicle as configured with a sport memorabilia novelty body. As shown the universal vehicle chassis assembly 17 is mated to the quick-change sports memorabilia body 45 shown. The universal vehicle chassis assembly 17 clearly indicates the placement and importance of left rear drive motor wheel assembly 33, left front drive motor wheel assembly 40, flexible left side drive wheel track traction enhancement ridge 21. Said track's 8 tension can be adjusted via the inflation of the molded balloon tire 40 through inflation port 35. This figure also clearly shows the versatility and imaginative nature of this invention with optional features such as auxiliary high intensity LED area lights 41, mounted digital video camera 42 and a body configuration allowing a storage compartment that is side mounted on the quick change sports memorabilia body 43 with storage compartment 44. The body cover 46 is removable and or operable 46 via a cover gripping port 47 and optional hinge for top cover 48 and an insulated storage compartment 49.

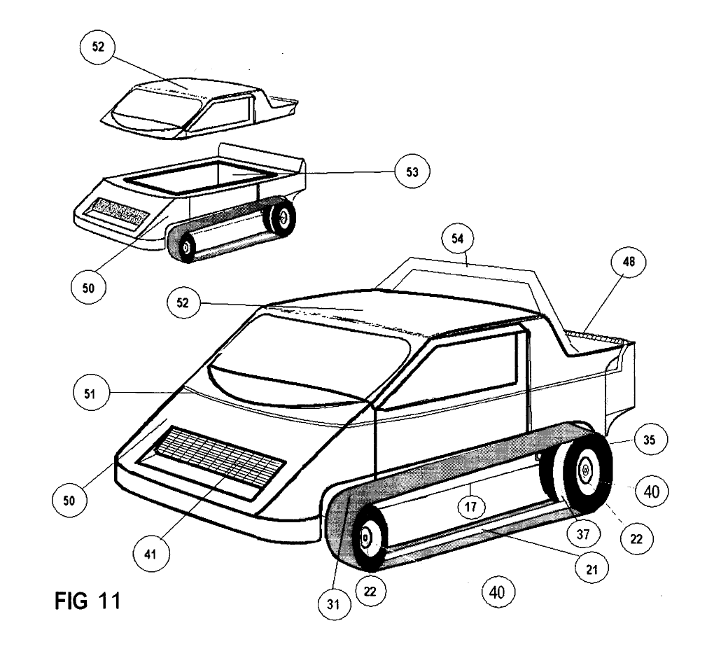

FIG. 11 illustrates an embodiment of the invention configured with the small sized toy style automotive body configuration. Universal vehicle chassis assembly 17 is mated to the embodiment of the quick-change sport body 45 in this embodiment. Universal vehicle chassis Assembly 17 clearly indicates the placement and importance of left rear drive motor wheel assembly 40, left front drive motor wheel assembly 34 and flexible left side track's traction enhancement ridge 21 and that the track's 31 tension is controlled by adjustment of the inflation of the molded balloon tire 40 through its inflation port 35.

This figure also clearly shows the versatility and imaginative nature of this invention. With optional features such as auxiliary high intensity LED area lights 41, lower half and mating section of quick change body 50, mating seam between the lower and upper halves of the body 51, cover for the insulated internal storage compartment 52 and insulated internal storage compartment 53 with body carrying handle 54.

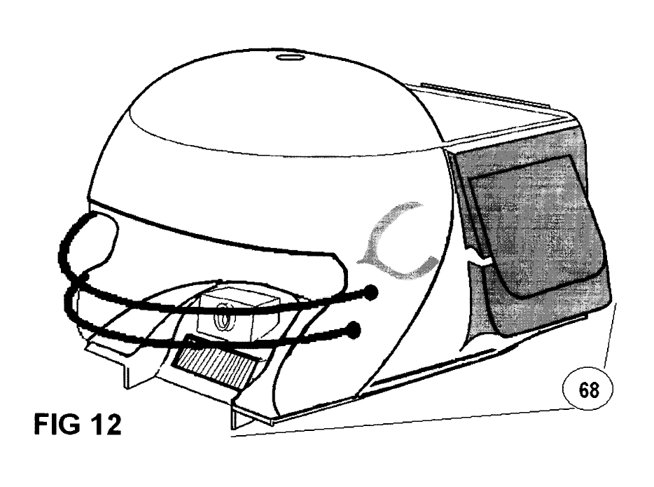

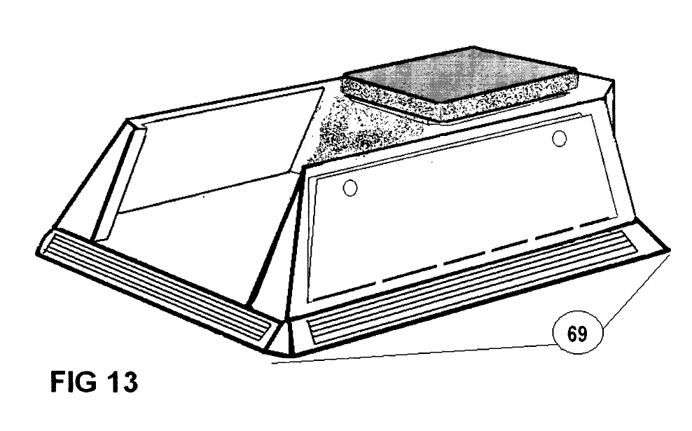

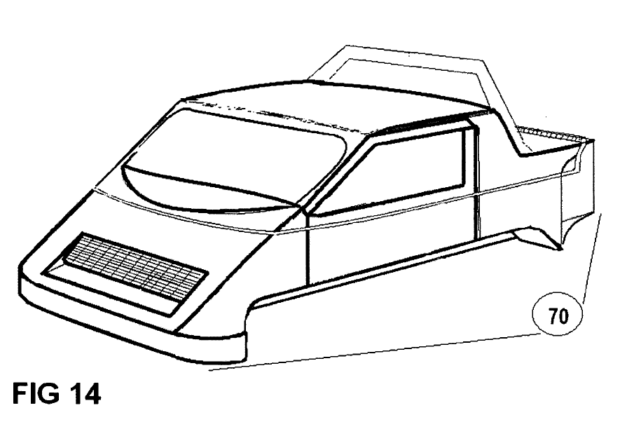

FIGS. 12-14 demonstrate the versatility of the sized quick change bodies of the PUV. FIG. 12 shows a first embodiment of the PUV configured for the sports fan with a memorabilia design 68. FIG. 13 is for the user looking to get the job done with the utility design 69.

Finally, the last illustration shows the PUV configured for the racing fan as the PUV is redesigned for the automotive style quick change body 70.

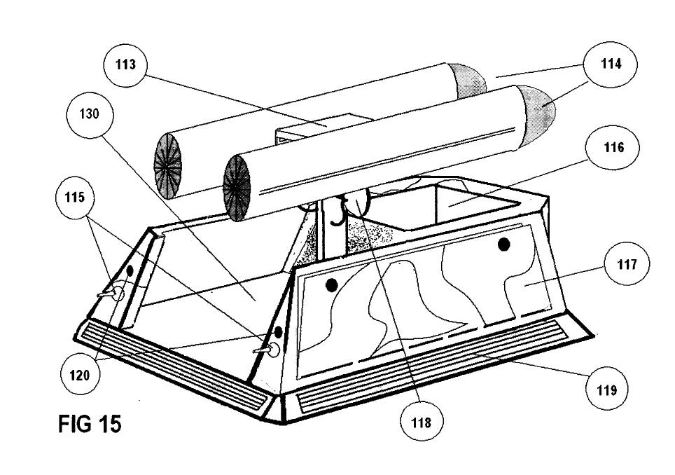

FIG. 15 illustrates an embodiment of the invention configured as a CRUDV (Combat Ready Utility Delivery Vehicle) while still maintaining the functionality of adaptability via the quick-change body and designed to carry military type cargo of to 2500 Lbs or more. This embodiment also demonstrates the utility capabilities of the PUV as modified for military applications. Wherein the sized and armored 117 or unarmored quick change utility body style shown herein at FIG. 15. This embodiment illustrates the CRUDV with a combat missile launcher 114 and or a built-in chemical delivery system 115. This configuration also has an infrared vision 118 and or nighttime illumination system 119. The combination of real time on board night vision cameras, two-way communications, built-in weapons tracking system 116 and remote control operation allows the operator to remain in a secure location and remotely operate the vehicle in a standalone operation or as a direct troop support vehicle. The PUV communications systems can be quickly changed out and replaced with a communications systems allowing for multiple RF (radio frequencies) for specialized applications. Proximity sensors may also be installed so that the CRUDV (Combat Ready Utility Delivery Vehicle) can “watch” for hostility on a 360 degree pattern. This embodiment as described provides the versatility to meet most military needs, with on board automatic target tracking 113, and terrain radar, remote controlled small and medium arms delivery platform. This unit could be configured to be a weapons platform delivery vehicle for whatever application the military would want or need of a vehicle of it size and capabilities. Possible configurations could include a towing vehicle, an equipment hauler or an expendable explosive delivery system. Other possible configurations could include use as a wounded solider retrieval vehicle. In another embodiment, the personal utility vehicle may be configured with appropriate sensors for the battlefield environment as a threat detection vehicle, which could include, but would not be limited to sensors for biological or radiation monitoring. (Not shown)

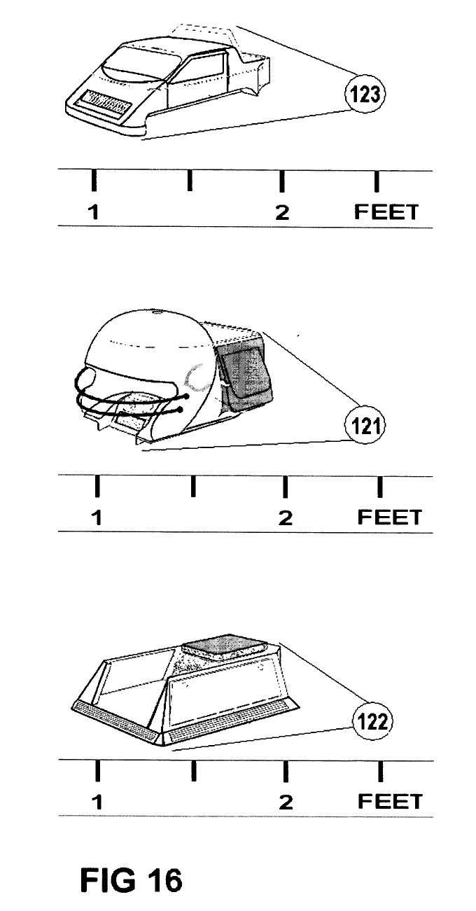

FIGS. 16-18 demonstrate the versatility of the sized quick change bodies of the PUV. The illustration at the top of FIG. 16 another embodiment of the PUV as a smaller configuration with an automotive body 128 design for cargos in mass up to 50 pounds. Also shown in FIG. 16 is the small configuration of the PUV's as memorabilia design 126. Finally, the last illustration shows the PUV as configured for smaller cargos, below 50 pounds with the utility design 127.

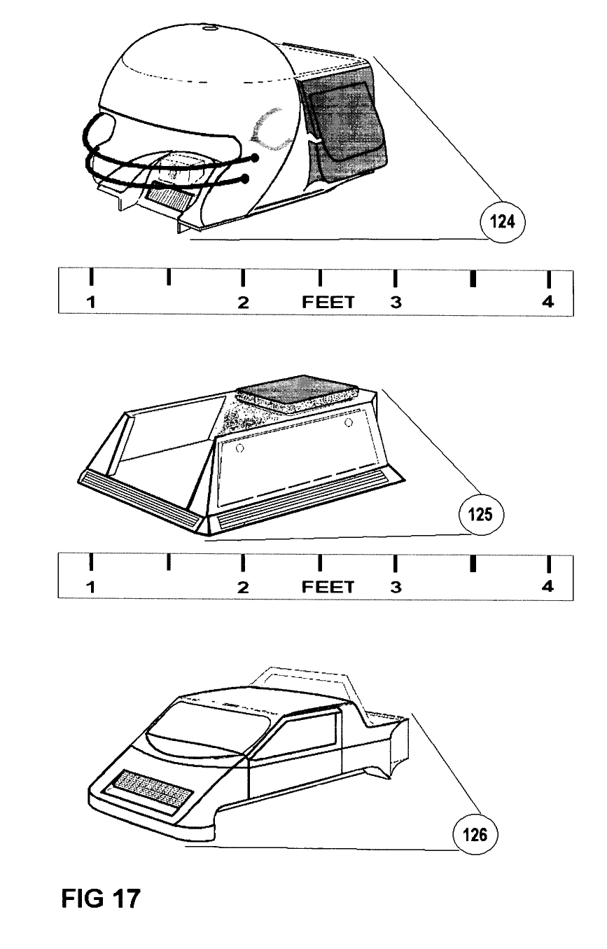

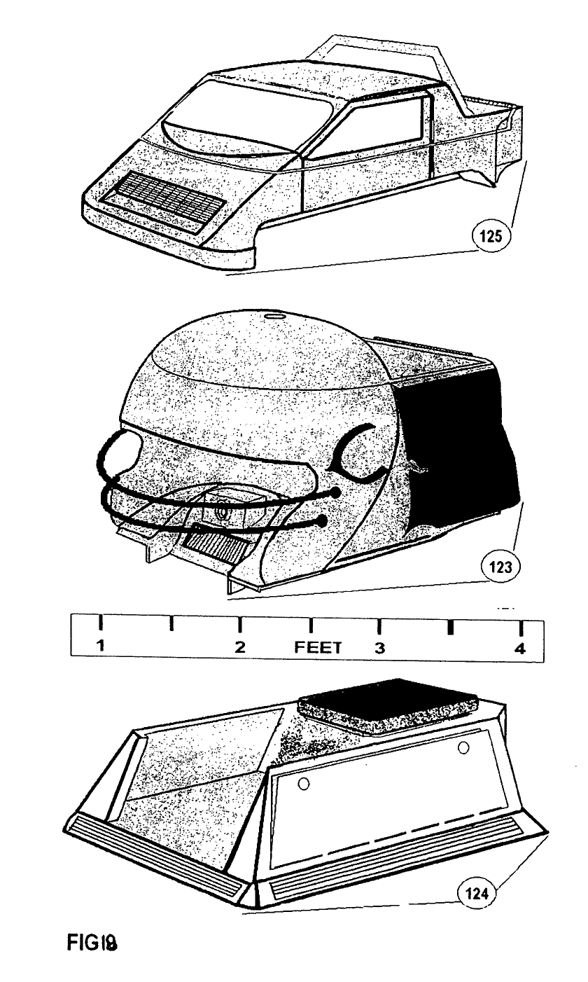

The illustration at the top of FIG. 17 details another embodiment of the PUV as a medium configuration with a sports memorabilia body 120 design for cargos in mass between five and one-hundred pounds. Also shown in FIG. 17 is the medium configuration of the PUV in the utility design 121. Finally, the last illustration shows the PUV as configured for medium cargos with the automotive design 122.

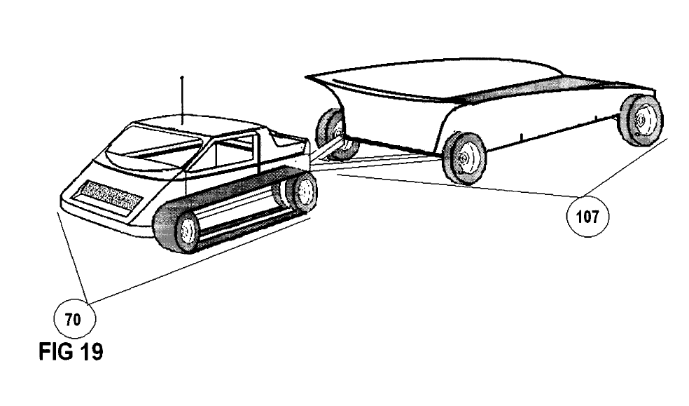

The illustration at the top of FIG. 18 shows another embodiment of the PUV as a larger configuration with an automotive body 125 design for cargos in mass from one-hundred to five-hundred pounds. Also shown in FIG. 18 is the large configuration of the PUV as a memorabilia design 123. Finally, the last illustration shows the PUV as configured for larger cargos with the utility design 124. FIG. 19 shows another embodiment of the PUV as configured with an automotive style quick change body 70 with the addition of trailering accessories 107 for additional cargo handling capabilities.

1. A personal utility vehicle comprising:
a. a universal chassis assembly, said universal chassis assembly having first and second ends and first and second sides;
b. a first drive system, said first drive system positioned at said first end of said universal chassis assembly, said first drive system further comprising first and second bi-directional motors opposably positioned at said first end of said universal chassis assembly;
c. a second drive system, said second drive system positioned at said second end of said universal chassis assembly, said second drive system further comprising first and second bi-directional motors opposably positioned at said second end of said universal chassis assembly;
d. a first flexible track assembly, said first flexible track assembly configured to be driven by the combined actions of said first sides of said first and second drive systems;
e. a second flexible track assembly, said second flexible track assembly configured to be driven by the combined actions of said second sides of said first and second drive systems, wherein said first and second flexible track assemblies parallelly positioned;
f. a mating tray mount assembly, said mating tray mount assembly having a top and bottom portion wherein said bottom portion is securably engaged to said universal chassis assembly;
g. a body, said body cooperatively engaged with said mating tray mount assembly; and,
h. a power source, said power source providing energy for said bi-directional motors to motivate said personal utility vehicle.

2. The personal utility vehicle as set forth in claim 1, wherein said universal chassis assembly has at least one compartment, said compartment housing said personal utility vehicle power source.

3. The personal utility vehicle as set forth in claim 2, wherein said mating tray mount assembly has a mounting channel, said mounting channel allowing detachable securement of said body.

4. The personal utility vehicle as set forth in claim 1, wherein said personal utility vehicle is configured for an electronic control system, said electronic control system comprising a central processing unit and circuitry connecting said power source and said bi-directional drive motors to said electronic control system.

5. The personal utility vehicle as set forth in claim 4, wherein said electronic control system includes a variable frequency drive to control the amount of power delivered to said bi-directional drive motors.

6. The personal utility vehicle as set forth in claim 4, wherein said mating tray mount is configured for placement of said electrical control system.

7. The personal utility vehicle as set forth in claim 6, wherein said electrical control system is configured as a main electronics board, said main electronics board arranged for placement upon said mating tray mount.

8. The personal utility vehicle as set forth in claim 7, wherein mating tray mount is configured with a swivel socket, said swivel socket allowing interchangeable placement or replacement of said main electronics board.

9. The personal utility vehicle as set forth in claim 8, wherein said body has electrical accessories requiring electrical connection to said electrical control system.

10. The personal utility vehicle as set forth in claim 9, wherein said mating tray mount has an interface terminal and wherein said electrical system of said body is configured for connection with said interface terminal of said mating tray mount allowing connection between said electrical control system and electrical accessories mounted to said body.

11. The personal utility vehicle as set forth in claim 8, wherein said electrical system of said body is configured for connection with said interface terminal of said mating tray mount.

12. The personal utility vehicle as set forth in claim 6, wherein said body has at least one storage compartment.

13. The personal utility vehicle as set forth in claim 10, wherein said body has at least one storage compartment.

14. The personal utility vehicle as set forth in claim 12, wherein said storage compartment may be refrigerated.

15. The personal utility vehicle as set forth in claim 13, wherein said storage compartment may be refrigerated.

16. The personal utility vehicle as set forth in claim 6, wherein armaments useful for enemy engagement may be mounted to said body.

17. The personal utility vehicle as set forth in claim 10, wherein armaments useful for enemy engagement may be mounted to said body.

18. The personal utility vehicle as set forth in claim 13, wherein armaments useful for enemy engagement may be mounted to said body.

19. The personal utility vehicle as set forth in claim 6, wherein said electrical accessories are comprised of an accessory selected from the group consisting of global positioning systems, cameras, video systems, environmental systems, lighting systems, television systems, radio systems and combinations thereof.

20. The personal utility vehicle as set forth in claim 10, wherein said electrical accessories are comprised of an accessory selected from the group consisting of global positioning systems, cameras, video systems, environmental systems, lighting systems, television systems, radio systems and combinations thereof.

21. The personal utility vehicle as set forth in claim 13, wherein said electrical accessories are comprised of an accessory selected from the group consisting of global positioning systems, cameras, video systems, environmental systems, lighting systems, television systems, radio systems and combinations thereof.

22. The personal utility vehicle as set forth in claim 6, wherein said bodies are comprised of a body selected from the group consisting of sports memorabilia, utility, automotive, military and combinations thereof.

23. The personal utility vehicle as set forth in claim 10, wherein said bodies are comprised of a body selected from the group consisting of sports memorabilia, utility, automotive, military and combinations thereof.

24. The personal utility vehicle as set forth in claim 13, wherein said bodies are comprised of a body selected from the group consisting of sports memorabilia, utility, automotive, military and combinations thereof.

25. The personal utility vehicle as set forth in claim 2, wherein the first and second drive systems further comprise a first and second axle, said first and second axles positioned for engagement between each of said bi-directional motors and flexible track assemblies, wherein said flexible track assemblies further comprise:
a. a drive wheel assembly for attachment to said first and second axles opposite said bi-directional motor end;
b. an inflatable balloon tire for cooperative engagement with said wheel assembly, said inflatable balloon tire having an annular groove at its outer diameter and an inflation means for varying the internal pressure of said inflatable balloon tire; and
c. a traction enhancement groove, said traction enhancement groove located along the inner surface of said flexible track assembly wherein the tension of said flexible track assemblies may be independently controlled through inflation means of said balloon tires.

26. The personal utility vehicle as set forth in claim 25, wherein said drive wheel assembly is comprised of three cooperatively engaged portions.

27. The personal utility vehicle as set forth in claim 25, wherein said balloon tire inflation means are connected to an air supply found within said personal utility vehicle and the tension applied to said balloon tire by said flexible track is responsive to environmental surface conditions.

28. The personal utility vehicle as set forth in claim 27, wherein said air supply is controlled by said electrical control system.

29. The personal utility vehicle as set forth in claim 28, wherein the control of said air delivered to said balloon tires to manage tension applied to traction enhancement ridges of said flexible tracks is dynamically responsive to environmental surface conditions.

30. The personal utility vehicle as set forth in claim 25, further comprising a set of idler load bearing wheels mounted to said chassis assembly for engagement with said track assemblies.

31. The personal utility vehicle as set forth in claim 30, wherein said idler load bearings wheels are powered.

32. The personal utility vehicle as set forth in claim 6, wherein said personal utility vehicle may be remotely operated using data collected using data collection systems selected from the group consisting of global positioning systems, camera systems, environmental sensor systems, lighting systems, television systems, radio systems and combinations thereof.

33. The personal utility vehicle as set forth in claim 10, wherein said personal utility vehicle may be remotely operated using data collected using data collection systems selected from the group consisting of global positioning systems, camera systems, environmental sensor systems, lighting systems, television systems, radio systems and combinations thereof.

34. The personal utility vehicle as set forth in claim 13, wherein said personal utility vehicle may be remotely operated using data collected using data collection systems selected from the group consisting of global positioning systems, camera systems, environmental sensor systems, lighting systems, television systems, radio systems and combinations thereof.

35. The personal utility vehicle as set forth in claim 26, wherein said personal utility vehicle may be remotely operated using data collected using data collection systems selected from the group consisting of global positioning systems, camera systems, environmental sensor systems, lighting systems, television systems, radio systems and combinations thereof.

36. The personal utility vehicle as set forth in claim 35, wherein said personal utility vehicle may be remotely operated using computer controls allowing voice activation and recognition instructions for control of said personal utility vehicle.

37. A personal utility vehicle control system allowing semi-autonomous control of said personal utility vehicle comprising:
a. a personal utility vehicle having a powered drive system;
b. an electronic control system, said electronic control system for directing said powered drive system;
c. a user emitter, said user emitter to be used by the operator of the personal utility vehicle, said user emitter configured to transmit a sonic signal;
d. a pair of reference stereoscopic microphones, said pair of reference stereoscopic microphone attached to said personal utility vehicle and configured to receive a sonic signal transmitted from said user emitter;
e. a first stereoscopic microphone and a first powered stereoscopic microphone turning means, said first powered stereoscopic turning means mounted upon said personal utility vehicle and connected to said first stereoscopic microphone and configured to track and receive a sonic signal transmitted from said user emitter;
f. a second stereoscopic microphone and a second powered stereoscopic microphone turning means, said second powered stereoscopic turning means mounted upon said personal utility vehicle and connected to said second stereoscopic microphone and configured to track and receive a sonic signal transmitted from said user emitter, wherein said first and second stereoscopic microphones are positioned on opposite sides of said pair of reference stereoscopic microphones; and,
g. a computer based central process controller, said computer based central process controller allowing responsive control of said personal utility vehicle, dependent upon the spatial relationship between said user emitter and said personal utility vehicle further comprising:
i. a set of commands for control of said personal utility vehicle, said set of commands pre-programmed into said central process controller for directing control of said personal utility vehicle through said electrical control system;
ii. a tracking means, said tracking means configured to control said first and second stereoscopic microphone turnings means;
iii. a signal measuring means, said measuring means measuring signals received by said reference, first and second stereoscopic microphones;
iv. a signal comparison means, said comparison means comparing signals received by said reference, first and second stereoscopic microphones;
v. an analysis means, said analysis means analyzing the results of said signal measuring and comparison means, said analysis means selecting an appropriate command from said pre-programmed commands to allow said personal utility vehicle to track said user emitter signal;
vi. an execution means, said execution means transmitting the command selected by said analysis means to said electrical control system of said personal utility vehicle to responsively control said powered drive system.

38. A personal utility vehicle control system as set forth in claim 37, further comprising a global positioning system receiver, wherein said control system integrates the coordinates received by said receiver to control said personal utility vehicle.

39. A personal utility vehicle control system as set forth in claim 38, further comprising a second global positioning system receiver integrated into said user emitter wherein said personal utility vehicle control system integrates the coordinates received by both of said global positioning system receivers to control said personal utility vehicle.

40. The personal utility vehicle as set forth in claim 36, wherein said personal utility vehicle may also be remotely operated using data collected using data collection systems selected from the group consisting of personal utility vehicle monitoring systems, global positioning systems, camera systems, environmental sensor systems, lighting systems, television systems, video systems, radio systems and combinations thereof.

41. A personal utility vehicle comprising:
a. a universal chassis assembly, said universal chassis assembly having first and second ends and first and second sides;
b. a first drive system, said first drive system positioned at said first end of said universal chassis assembly, said first drive system further comprising first and second bi-directional motors opposably positioned at said first end of said universal chassis assembly;
c. a second drive system, said second drive system positioned at said second end of said universal chassis assembly, said second drive system further comprising first and second bi-directional motors opposably positioned at said second end of said universal chassis assembly;
d. a first flexible track assembly, said first flexible track assembly configured to be driven by the combined actions of said first sides of said first and second drive systems;
e. a second flexible track assembly, said second flexible track assembly configured to be driven by the combined actions of said second sides of said first and second drive systems, wherein said first and second flexible track assemblies parallelly positioned;
f. a mating tray mount assembly, said mating tray mount assembly having a top and bottom portion wherein said bottom portion is securably engaged to said universal chassis assembly;
g. a body, said body cooperatively engaged with said mating tray mount assembly;
h. a power source, said power source providing energy for said bi-directional motors to motivate said personal utility vehicle; and,
i. a system allowing autonomous control of a personal utility vehicle.

42. A personal utility vehicle as set forth in claim 41, wherein said personal utility vehicle has a semi-autonomous control system comprising:
a. an electronic control system, said electronic control system for directing said first and second drive systems;
b. a user emitter, said user emitter to be used by the operator of the personal utility vehicle, said user emitter configured to transmit a sonic signal;
c. a pair of reference stereoscopic microphones, said pair of reference stereoscopic microphone attached to said personal utility vehicle and configured to receive a sonic signal transmitted from said user emitter;
d. a first stereoscopic microphone and a first powered stereoscopic microphone turning means, said first powered stereoscopic turning means mounted upon said personal utility vehicle and connected to said first stereoscopic microphone and configured to track and receive a sonic signal transmitted from said user emitter;
e. a second stereoscopic microphone and a second powered stereoscopic microphone turning means, said second powered stereoscopic turning means mounted upon said personal utility vehicle and connected to said second stereoscopic microphone and configured to track and receive a sonic signal transmitted from said user emitter, wherein said first and second stereoscopic microphones are positioned on opposite sides of said pair of reference stereoscopic microphones; and,
f. a computer based central process controller, said computer based central process controller allowing responsive control of said personal utility vehicle, dependent upon the spatial relationship between said user emitter and said personal utility vehicle further comprising:
i. A set of commands for control of said personal utility vehicle, said set of commands pre-programmed into said central process controller for directing control of said personal utility vehicle through said electrical control system;
ii. A tracking means, said tracking means configured to control said first and second stereoscopic microphone turnings means;
iii. A signal measuring means, said measuring means measuring signals received by said reference, first and second stereoscopic microphones;
iv. A signal comparison means, said comparison means comparing signals received by said reference, first and second stereoscopic microphones;
v. An analysis means, said analysis means analyzing the results of said signal measuring and comparison means, said analysis means selecting an appropriate command from said pre-programmed commands to allow said personal utility vehicle to track said user emitter signal;
vi. An execution means, said execution means transmitting the command selected by said analysis means to said electrical control system of said personal utility vehicle to responsively control said powered drive system.

43. A personal utility vehicle as set forth in claims 42, wherein said computer based controller uses a set of commands selected from the group consisting of start, shutdown, standby, sleep, awake, analysis, sample, run, seek and combinations thereof.

44. A personal utility vehicle as set forth in claim 43, wherein said computer based controller recognizes and accepts voice activated commands for control of said personal utility vehicle.

45. A personal utility vehicle as set forth in claim 41, further comprising a proportional energy control circuit to control said first and second drive systems of the personal utility vehicle for motivation and direction control.

46. A personal utility vehicle as set forth in claim 41, further comprising a set of computer controls allowing voice activation and recognition instructions for control of said personal utility vehicle.

47. A personal utility vehicle as set forth in claim 42, further comprising a set of computer controls allowing voice activation and recognition instructions for control of said personal utility vehicle.

48. A personal utility vehicle as set forth in claim 42, further comprising a set of computer controls allowing voice activation and recognition instructions for control of said personal utility vehicle.

49. A personal utility vehicle as set forth in claim 42, wherein said personal utility vehicle is configured for military use as a towing vehicle.

50. A personal utility vehicle as set forth in claim 42, wherein said personal utility vehicle is configured for military use as an equipment hauler.

51. A personal utility vehicle as set forth in claim 42, wherein said personal utility vehicle is configured for military use as an expendable explosive delivery system.

52. A personal utility vehicle as set forth in claim 42, wherein said personal utility vehicle is configured for military use as a weapons delivery platform.

53. A personal utility vehicle as set forth in claim 42, wherein said personal utility vehicle is configured for military use as a wounded solider retrieval vehicle.

54. A personal utility vehicle as set forth in claim 42, wherein said personal utility vehicle is configured for military use as a battlefield environment threat detection vehicle.

55. A personal utility vehicle as set forth in claim 55, wherein said personal utility vehicle is configured with sensors for biological or radiation monitoring.

56. A personal utility vehicle comprising:
a. a chassis assembly means;
b. a drive means; said drive means affixed to said chassis assembly means;
c. a surface engagement means; said surface engagement means configured for powered motivation by said drive means;
d. an interchangeable mating means, wherein said interchangeable mating means is affixed to said chassis assembly means;
e. a body means, said body means configured for cooperative engagement with said interchangeable mating means;
f. a power source, said power source providing energy for said drive means; and,
g. a semi-autonomous control system means, said semi-autonomous control system means allowing control of said personal utility vehicle wherein said body means may be disengaged from said interchangeable mating means to allow for selection of alternative configurations of said body means to be placed on said chassis assembly means.

57. A personal utility vehicle as set forth in claim 57, wherein said surface engagement means are flexible tracks.

58. A personal utility vehicle as set forth in claim 58, wherein the tension of said surface engagement means may be changed in response to user needs.

59. A personal utility vehicle as set forth in claim 59, wherein the tension of said surface engagement means automatically responds to environmental conditions.

60. A personal utility vehicle as set forth in claim 58, wherein said semi-autonomous control system is located within said interchangeable mating means.

61. A personal utility vehicle as set forth in claim 57, wherein said surface engagement means are flexible tracks.

62. A personal utility vehicle as set forth in claim 57, wherein said personal utility vehicle may configured for use with external data collected using data collection systems selected from the group consisting of global positioning systems, camera systems, environmental sensor systems, lighting systems, television systems, video systems, radio systems and combinations thereof.

63. An active flexible track assembly comprising:
a. a plurality of drive wheels;
b. a first axle having first and second ends; said first axle having a drive wheel attached to said first and second ends;
c. a second axle having first and second ends; said second axle having a drive wheel attached to said first and second ends;
d. a power source to drive said first and second axles;
e. a plurality of inflatable balloon tires for cooperative engagement with of each said drive wheels, each of said inflatable balloon tires having an annular groove at its outer diameter and an inflation means for varying the internal pressure of said inflatable balloon tire; and,
f. a flexible track assembly arranged to encompass said balloon tires, wherein said flexible track has a traction enhancement groove, said traction enhancement groove located along the inner surface of said flexible track assembly wherein the tension of said flexible track assemblies may be independently controlled through inflation means of said balloon tires.
